(19) United States
(12) Patent Application Publication
(10) Pub. No.: US 2007/0072046 A1
(43) Pub. Date: Mar. 29, 2007

(54) Electrochemcial cell structures and methods of making the same

(75) Inventors: Anthony Mark Thompson, Niskayuna, NY (US); David John Wortman, Hamilton, OH (US); Harish Radhakrishna Acharya, Clifton Park, NY (US); Richard Arthur Nardi JR., Scotia, NY (US); Yuk-Chiu Lau, Ballston Lake, NY (US); Kenneth Walter Browall, Saratoga Springs, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/235,554

(22) Filed: Sep. 26, 2005

(51) Int. Cl. H01M 8/02; H01M 4/86

(52) U.S. Cl. 429/38; 429/44; 429/45; 429/35

(57) ABSTRACT

An electrochemical cell structure comprises a conductive base, that defines a plurality of holes, and a grid layer disposed on the conductive base. A porous support layer at least partially interpenetrates the grid layer to at least one of the conductive base or the holes.

### CROSS REFERENCE TO RELATED APPLICATIONS

This application is related to co-pending U.S. patent application, Docket Number 145463-2, Ser. No.,______, entitled “Substrates For Deposited Electrochemical Cell Structures And Methods Of Making The Same,” and co-pending U.S. patent application, Docket Number 163855-1, Ser. No., ______, entitled “Solid Oxide Fuel Cell Structures, and Related Compositions and Processes,” each filed contemporaneously herewith, which applications are hereby incorporated by reference.

### BACKGROUND

The invention relates generally to electrochemical cell structures and more specifically to improved electrochemical cell construction and enhanced fabrication and processing techniques related thereto.

Electrochemical cells are energy conversion devices that are usually classified as either electrolysis cells or fuel cells. Electrolysis cells can function as hydrogen generators by electrolytically decomposing water to produce hydrogen and oxygen gases. Fuel cells electrochemically react a hydrogen gas with an oxidant across an exchange membrane or an electrolyte to generate electricity and produce water. Fuel cells, such as solid oxide fuel cells, have demonstrated a potential for high efficiency and low pollution and have many potential applications including large-scale power generation, distributed power and use within automobiles.

One of the key challenges related to electrochemical cell advancement is to develop cost effective processes to manufacture electrode and electrolyte materials, especially with large surface areas.

Accordingly there is a need in the art for improved electrochemical cell design and associated fabrication techniques.

### BRIEF DESCRIPTION

An electrochemical cell support structure comprises a conductive base that defines a plurality of holes, and a grid layer disposed on the conductive base. A porous support layer at least partially interpenetrates the grid layer to at least one of the conductive base or the holes.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of one embodiment of the invention with parts removed.

FIG. 2 is another perspective view of one embodiment of the invention with parts removed.

FIG. 3 is a cross-sectional side view of one embodiment of the invention.

FIG. 4 is a top view with parts removed of another embodiment of the invention.

FIG. 5 is a schematic representation of one embodiment of the invention.

FIG. 6 is a flow chart depicting method steps associated with one embodiment of the instant invention.

FIG. 7 is a cross-sectional side view of another embodiment of the invention.

### DETAILED DESCRIPTION

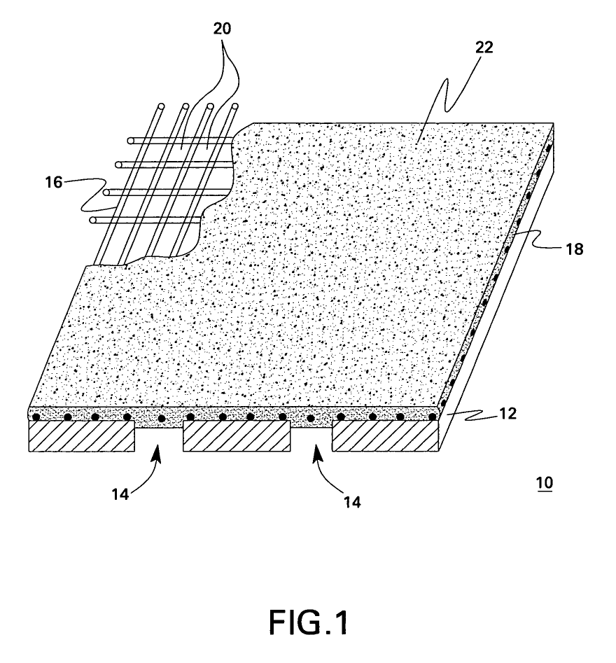

An electrochemical cell support structure 10 comprises a conductive base 12 that defines a plurality of holes 14 that pass through the conductive base 12, a grid layer 16 disposed on the conductive base 12 and a porous support layer 18 at least partially interpenetrating the grid layer 16, as shown in FIG. 1.

As discussed above, one of the challenges related to electrochemical cells is the associated fabrication and manufacturing techniques, especially for larger surface area applications. In some conventional cell designs, cells are fabricated using traditional ceramic processing technologies and the ceramic cells are bonded to a metallic interconnect using a bond paste. The bond paste is a source of resistance losses within the cell structure. In alternative processes, such as the direct deposition of fuel cells, the quality of the electrolyte is dependent on the roughness of and imperfections in the underlying electrode (onto which the electrolyte is being deposited). Undulations in the electrode layer can create imperfections in the cell fabrication, especially in high-speed deposition techniques. One of the imperfections created are pinhole leaks throughout the cell. One solution to this issue has been to polish the surface of the electrode after deposition. This solution, however, creates another process step that is not expected to be robust for large area deposition and adds inefficiencies into an already inefficient process.

Electrochemical cell support structure 10 addresses each of these issues. The grid layer 16 is disposed on the conductive base 12 and the porous support layer 18 interpenetrates into the grid layer 12. This arrangement does not require a bond paste and the components are much less likely to separate during use and are therefore more structurally stable than conventional arrangements. Additionally, the porous support layer 18 provides a relatively smooth surface to support atomistic deposition techniques such as chemical vapor deposition (CVD), plasma enhanced CVD (PE-CVD), physical vapor deposition (PVD), electron beam physical vapor deposition (EB-PVD), sputter deposition, ion beam deposition, molecular beam epitaxy (MBE), spray pyrolysis or particulate deposition techniques such as plasma spray, flame spray, or high-velocity oxygen fuel thermal spray process (HVOF) or other deposition techniques.

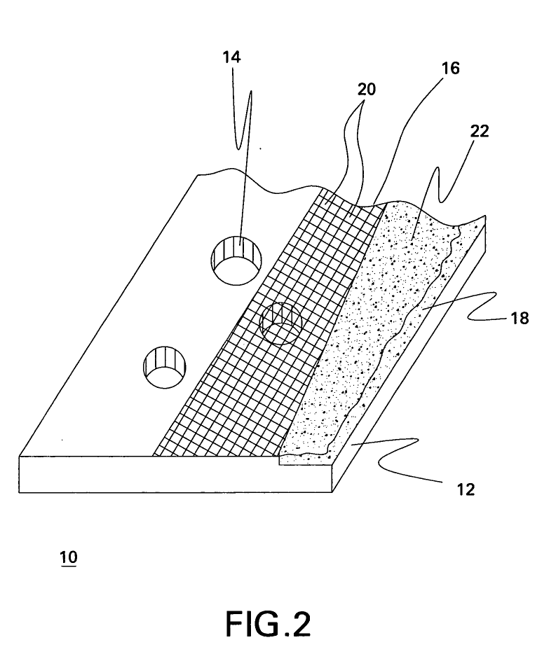

As shown in FIG. 1-FIG. 3, conductive base 12 comprises a plate-type structure that includes a series of holes 14 that pass through, allowing fluid flow, for example fuel or oxidant flow, to flow from one side of conductive base 12 to an opposite side of conductive base 12. In one embodiment, the holes have a diameter between about 0.25 inches to about 0.50 inches. As discussed herein, the term “holes” refers to any type of void, groove or other cavity arrangement that allows fluid flow to pass from one side of conductive base 12 to the opposite side. Conductive base 12 is typically made of metals that oxidize slowly under the operating conditions associated with solid oxide fuel cell (SOFC) and solid oxide electrolyzer cell (SOEC) applications, namely, high temperatures and pressures. Conductive base 12 is typically a metallic interconnect made of iron, chromium, nickel, tin, combinations thereof or other materials conventionally used as interconnect materials, especially in SOFC and SOEC applications. Such materials conventionally include for example, chromium-containing alloys, for example, iron chromium (FeCr), nickel chromium (NiCr), or nickel iron chromium (NiFeCr) based alloys. In one embodiment, conductive base 12 is made of ferritic stainless steel. The dimensions of conductive base 12 and the accompanying holes 14 can vary greatly depending on the application and size requirements. In one embodiment, conduction base 12 has an outer perimeter that does not have holes 14 such that an electrolyte or seal material can be overlapped with the perimeter to seal the gas flow therein.

The grid layer 16 is disposed on conductive base 12. The grid layer 16 is typically positioned to overlay the top surface of the conductive base 12, including the holes 14. The grid layer 16 is typically attached to conductive base 12 to ensure structural integrity using any available process to ensure bonding, for example brazing or welding. For purposes of discussion, each open area within grid layer 16 will be referred to as an interstice 20. Grid layer 16 is typically a steel wire grid, a screen, a metallic wire grid, conductive foam, a chromia former grid or similar materials. Grid layer 16 is typically made of metals that oxidize slowly under the operating conditions associated with solid oxide fuel cell (SOFC) and solid oxide electrolyzer cell (SOEC) applications, namely high temperatures and high pressures. Grid layer 16 is typically a metallic interconnect made of iron, chromium, nickel, tin, combinations thereof or other materials conventionally used as interconnect materials, especially in SOFC and SOEC applications. Such materials conventionally include for example, chromium-containing alloys, for example, FeCr, NiCr, or NiFeCr based alloys. In one embodiment, grid layer is made of a ferritic stainless steel.

The functional requirements of grid layer 16 are that it can be attached to conductive base 12 to ensure structural integrity and that it provides openings or interstices 20 to promote fluid flow and to engage the porous support layer 18 as discussed in greater detail below. The interstices 20 can have a variety of dimensions and are not required to have a uniform cross-section. In one embodiment, interstices 20 have a width in the range between about 20 to about 2500 microns.

As shown in FIG. 1-FIG. 3, porous support layer 18 is disposed onto grid layer 16 and penetrates or interpenetrates through the interstices 20 and coats the top surface of the grid layer 16 to create a smooth outer surface 22. In one embodiment, porous support layer 18 is an electrode material. The functional requirements of porous support layer 18 are that it penetrates through the interstices 20, promotes fluid flow through its porous structure and provides a relatively smooth outer surface 22 to enable deposition techniques. In one embodiment, the coefficient of thermal expansion (CTE) of the porous support layer 18 is substantially matched to the CTE of the grid layer 16 to avoid cracking during thermal cycling.

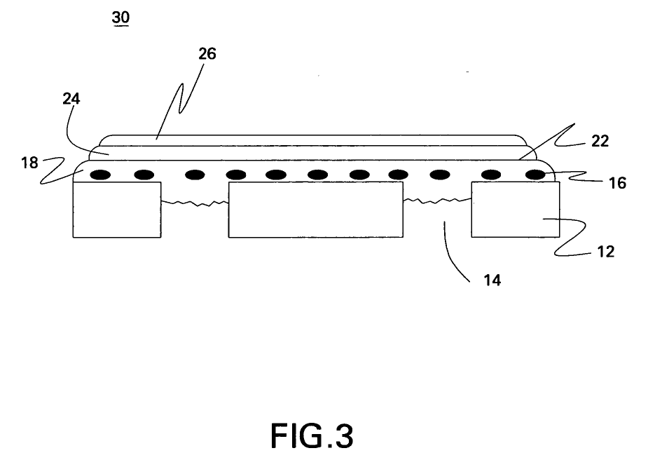

To complete the electrochemical cell structure 30, a dense electrolyte 24 (FIG. 3) is applied to the porous support layer 18, or in this case, first electrode 18. In one embodiment, electrolyte 24 is deposited onto smooth outer surface 22 of porous support layer 18 using a direct deposition method, for example physical vapor deposition (PVD) or plasma spray. Typically, dense electrolyte 24 completely covers the smooth outer surface 22 of the first electrode 18 such that no part of the smooth outer surface 22 is exposed. Finally, a second electrode 26 is applied to the electrolyte 24 opposite the first electrode 18. In one embodiment, second electrode 26 is deposited onto dense electrolyte 24 using a direct deposition method, for example PVD or alternatively by using screen-printing or paint spraying of liquid dispersed particles.

In one embodiment, electrochemical cell structure 10 (FIG. 1) is fabricated by first attaching a metallic grid layer 16 to a metallic perforated conductive base plate 12 using conventional processing such as brazing or welding. Next, first electrode 18 (porous support layer) is applied to the metallic grid layer 16. In one embodiment, first electrode 18 is applied by squeezing a deformable mass into the interstices 20 of the grid layer 16 using any conventional processing technique like screen printing. In another embodiment, first electrode 18 is applied to the metallic grid layer 16 by slip casting the powder form of the first electrode 18 into the grid layer 16 and using a porous backing sheet to remove any water. In another embodiment, first electrode 18 is applied to the metallic grid layer 16 using electropheretic deposition by dipping the metallic grid layer 16 and conductive base plate 12 into a slip and under an applied voltage, particles fill the interstices 20.

In another embodiment, first electrode 18 is applied to the metallic grid layer 16 using a co-casting technique such as tape casting. The metal grid 16, the base plate 12 and the first electrode 18 are then heated at temperatures between about 800 C and about 1200 C to create strong bonds between the particles of the first electrode 18. To enhance the catalytic activity of first electrode 18 or second electrode 26, (FIG. 3) they may be infiltrated by a liquid precursor of the electrode material or a fine dispersion of particles to develop a fine scale structure that would enhance the triple phase boundary area available for catalytic activity.

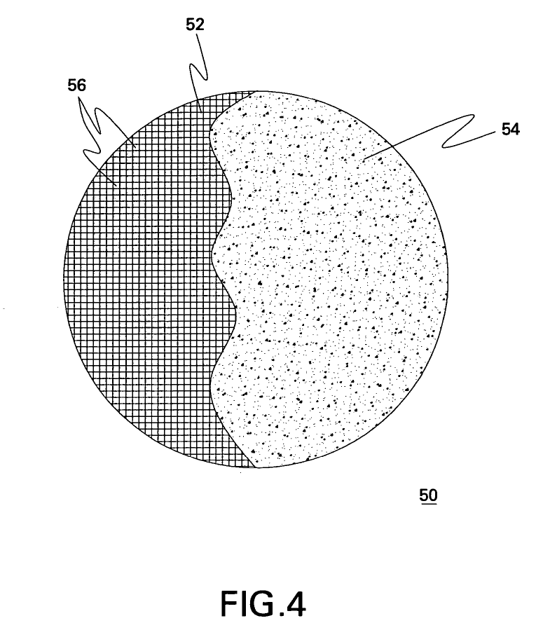

In another embodiment of the invention, an electrode cell structure 50 comprises a mesh substrate 52 and a porous electrode material 54 deposited upon and interpenetrating through the mesh substrate 52, as shown in FIG. 4.

As discussed above, one of the challenges related to electrochemical cells is the associated fabrication and manufacturing techniques, especially for larger surface area applications. In some conventional cell designs, cells are fabricated using traditional ceramic processing technologies and the ceramic cells are bonded to a metallic interconnect using a bond paste. One problem associated with the traditional ceramics processing is getting the resulting electrode material to form with an advantageous microstructure at a reduced thickness.

Electrode cell structure 50 addresses each of these issues. Mesh substrate 52 is a screen, typically either a stainless steel or a nickel screen or a metallic foil having a plurality of interstices 56 or openings. A suitable electrode material 54, for example nickel (Ni) and yttria stabilized zirconia (YSZ) is applied to mesh substrate 52 to create a microstructure having large columnar pores at the interstices 56 of the mesh substrate 52 and that taper to smaller openings. This columnar pore structure will promote fluid penetration (fuel or oxidant) into the electrode cell structure 50. In one embodiment, electrode material 54 is applied to both the top and bottom of mesh substrate 52. In this embodiment, mesh substrate 52 serves as a backbone to the resultant electrode to promote columnar pores and to structurally support the electrode and limit cracking.

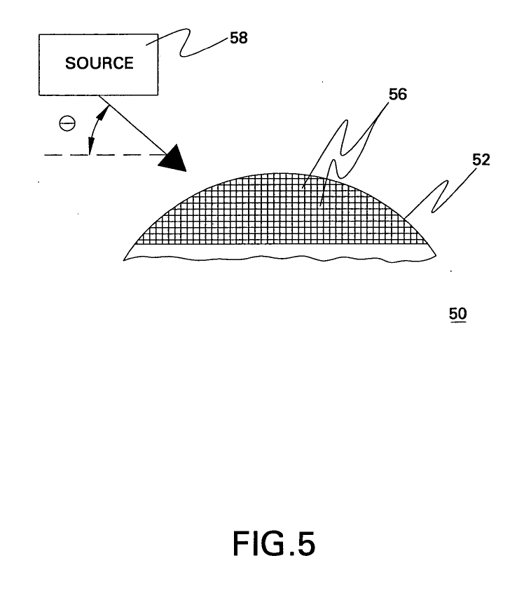

In one embodiment of the instant invention, as shown in FIG. 5, electrode material 54 is deposited onto mesh substrate 52 using a deposition system 58, for example an electron beam physical vapor deposition system (EB-PVD) or any other suitable deposition system. One advantage provided by using an EB-PVD system is that EB-PVD typically results in a fine microstructure with sub-micron grain sizes that is desirable in electrochemical cell structures.

In one embodiment, a stainless steel screen is used as mesh substrate 52, having a thickness of about 50 μm and diameter of the interstices of about 75 μm or smaller. The spacing of the interstices is also quite small, for example about 150 μm on center. Electrode material 54 is deposited onto the mesh substrate 52 by an EB-PVD process. In one embodiment, co-evaporation from two sources, for example nickel and YSZ, is used. In one embodiment, the deposition system 58 is positioned at an angle θ relative to normal with respect to the mesh substrate 52. In one embodiment, angle θ is between about 25° to about 65° and preferably between about 35° to about 55°. At these angles, shadowing occurs and allows the interstices 56 to gradually close up.

In an alternative embodiment, the interstices 56 are covered with a fugitive material, for example sodium chloride, prior to deposition. The fugitive material in the interstices reduces the size of the interstices while provided a growth defect at the site. The evaporation of the sodium chloride will also produce high levels of porosity within the electrode.

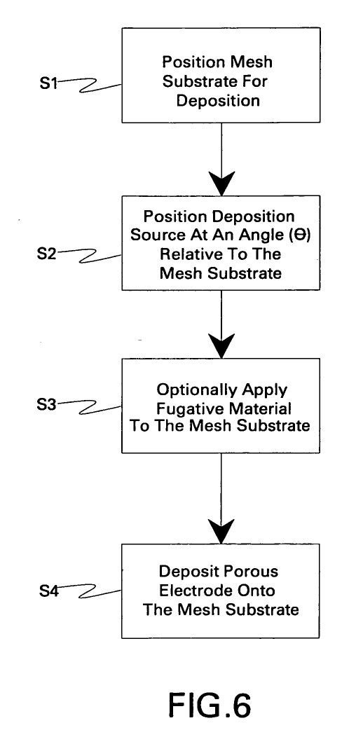

FIG. 6 is a flow chart depicting one process associated with this invention. In S1, the mesh substrate 52 is positioned for deposition. Next, in S2, the deposition source 58 is positioned at an angle θ relative to the mesh substrate. Next, a fugitive material is optionally applied to the mesh substrate in S3. Finally, in S4, porous electrode material 54 is deposited on the mesh substrate 52.

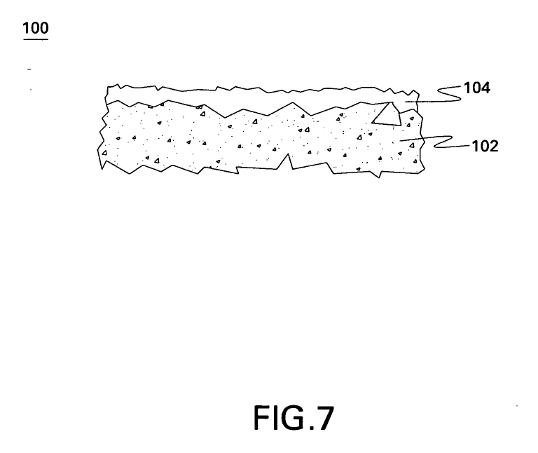

In another embodiment of the invention, an electrochemical cell structure 100 comprises a porous conductive base 102, for example metallic foam, and a support layer 104 deposited on the porous conductive base 102 and partially interpenetrating into the porous conductive base 102, as shown in FIG. 7. In one embodiment, the porous conductive base 102 comprises nickel foam. In another embodiment, support layer 104 is an electrode material.

The support layer 104 is disposed on the porous conductive base 102 and interpenetrates into the porous conductive base 102. This arrangement does not require a bond paste and the components are much less likely to separate during use and are therefore more structurally stable than conventional arrangements. Additionally, the support layer 104 provides a relatively smooth surface to support atomistic deposition techniques such as chemical vapor deposition (CVD), plasma enhanced CVD (PE-CVD), physical vapor deposition (PVD), electron beam physical vapor deposition (EB-PVD), sputter deposition, ion beam deposition, molecular beam epitaxy (MBE), spray pyrolysis or particulate deposition techniques such as plasma spray, flame spray, or high-velocity oxygen fuel thermal spray process (HVOF) or other deposition techniques. In one embodiment, support layer 104 is deposited onto porous conductive base 102 using a deposition technique such as PVD or EB-PVD.

As discussed herein, the electrolyte materials may comprise any conventional electrolyte material including, for example: yttria-stabilized zirconia; lanthanum gallate; doped cerium oxide; ceria-stabilized zirconia; a stabilized zirconia like CaO-stabilized zirconia, MgO-stabilized zirconia, M₂O₃ stabilized zirconia, where M is taken from the group of Y, Sc, Yb, Nd, Sm, or Gd; lanthanum gallate having a general composition of La_{1-x-w}Sr_{-x-w}Ga_{1-y}Mg_{y+z}O_{3-0.5(x+y+5w-2z)} where, 0.3≧x≧0.1; 0.3≧y≧0.1; 0.04≧w≧0.01; 0.15≧z≧0.03; doped cerium oxide where CeO₂ is doped with one or a mixture from La₂O₃, Y₂O₃, Sm₂O₃, Gd₂O₃, other rare earth oxides, Gd₂O₃+Pr₂O₃, CaO, SrO; certain stabilized Bismuthsesquioxides, Bi₂O₃-MO, where M is calcium, strontium or barium; Pyrochlore oxides of the general formula A₂B₂O₇, particularly Ln₂Zr₂O₇, where Ln is a lanthanoid such as Gd₂(ZrₓTi₁₋ₓ)₂O₇ (GZT) and Y₂(ZrₓTi₁₋ₓ)₂O₇ (YZT); or Perovskite structures such as BaCe_{0.9}Gd_{0.1}O₃, CaAl_{0.7}Ti_{0.3}O₃, SrZr_{0.9}Sc_{0.1}O₃; or combinations thereof.

As discussed herein, the electrode materials may comprise anode materials and cathode materials. The anode materials may comprise any conventional anode material including, for example: a mixture comprising an electronically conducting material such as at least one of a metal and a metal oxide that will be subsequently reduced to form the metal, and an ionically conducting material; at least one of nickel, nickel oxide, a platinum-group metal; a single phase of an electronically conducting materials; certain metals including Ni, Co, Pt, Pd or Ru; mixed oxide conductors including the ZrO₂—Y2O₃—TiO₂ system; or combinations thereof. The cathode materials may comprise any conventional cathode materials including, for example: a mixture comprising an electronically conducting material such as at least one of a metal and a metal oxide that will be subsequently reduced to form the metal and an ionically conducting material; at least one of nickel, nickel oxide or a platinum-group metal; lanthanum strontium manganite; doped lanthanum cobaltite; a mixture comprising at least one of a platinum-group metal, lanthanum strontium manganite, doped lanthanum ferrite, and doped lanthanum cobaltite and an electronically conducting material; doped lanthanum manganite; La MnO₃ substituted with various cations such as Ba, Ca, Cr, Co, Cu, Pb, Mg, Ni, K, Rb, Na, Sr, Ti, or Y; lanthanum strontium manganite having a general formula of La₁-xSrxMnO₃, which can also be further doped with Co or Cr; lanthanum cobaltite; LaCoO3 doped with Sr, Ca, Mn, or Ni to adjust conductivity or thermal expansion; doped lanthanum ferrite, for example Lao_{0.8}Sr_{0.2}FeₓCo_{y}O₃; or combinations thereof.

In addition, while the current invention is discussed in terms of two electrodes, a cathode and an anode, with an electrolyte disposed therebetween, other embodiment may include additional layers. For example, certain embodiments can include buffer layers deposited between the electrodes and the electrolyte. These buffer layers may be included for a variety of reasons including, without limitation, to prevent deleterious chemical interaction between the other layers. For example, some embodiments may include an interlayer of cerium-gadolinium oxide, or the like, that can be used to reduce the interdiffusion and chemical interaction between a layer of YSZ and a layer of lanthanum cobaltite, lanthanum strontium ferrite or mixtures thereof. Similarly, an interlayer of samarium-doped cerium oxide (Ce1-xSmxO2-0.5x) can be used to reduce the interdiffusion and chemical interaction between a composite anode of NiO: CeO₂ and LSGM (La_{1.8}Sr_{0.2}Ga_{1-y}Mg_{y}O_{2.9-0.5y}, where 0.05<y<0.3).

Several of the embodiments discussed within this specification provide a high porosity support or substrate for deposition, especially for large surface area deposition, with each support tailored for low gas transport resistance and robust to mechanical and thermal stresses. Additionally, several of the embodiments provide a relatively smooth outer surface that is suitable for a variety of deposition methods. The conductive base discussed in this invention is typically an interconnect, and more specifically, a metal interconnect. The porous or microporous support material or substrate material can comprise either the cathode material or the anode materials, or alternatively, the porous or microporous support material can comprise another layer such as a gas diffusion layer. In many of the embodiments, porous or microporous support material is the electrode and provides a relatively smooth surface for deposition of the remaining cell layers. Additionally, many of the embodiments involve the use of a mesh material, like screen, attached to the conductive base. Typically, this mesh material is made of the same or similar material of the conductive base. In the case where the conductive base and the mesh material are each made of an interconnect material, the resulting structures have improved mechanical durability, the current pathway is less sensitive to cracks that typically develop parallel to the electrode/interconnect surface since the current can travel laterally to the mesh material and then to the conductive base. Additionally, the dimensions of the unsupported electrode and electrolyte layers is greatly reduced to the smaller dimensions of the interstices of the mesh material, adding even more mechanical durability to the resultant cell.

While only certain features of the invention have been illustrated and described herein, many modifications and changes will occur to those skilled in the art. For example, while several of the embodiments of this invention have been discussed in terms of a fuel cell stack arrangement, this is not a limitation of the invention, in fact this invention is contemplated for use within other fuel cell arrangements including, for example, tubular fuel cell bundles or arrangements. It is, therefore, to be understood that the appended claims are intended to cover all such modifications and changes as fall within the true spirit of the invention.

1. An electrochemical cell support structure comprising:
a conductive base defining a plurality of holes passing through said conductive base;
a grid layer disposed on said conductive base; and
a porous support layer at least partially interpenetrating the grid layer to at least one of the conductive base or the holes.

2. An electrochemical cell support structure in accordance with claim 1, wherein said conductive base comprises a metallic interconnect made of at least one of iron, chromium, nickel, tin or combinations thereof.

3. An electrochemical cell support structure in accordance with claim 1, wherein said conductive base comprises a metallic interconnect made of ferritic stainless steel.

4. An electrochemical cell support structure in accordance with claim 1, wherein said plurality of holes have a dimension in the range between about 5 to about 13 millimeters.

5. An electrochemical cell support structure in accordance with claim 1, wherein said grid layer comprises a steel wire grid.

6. An electrochemical cell support structure in accordance with claim 1, wherein said grid layer comprises at least one of a screen, a metallic wire grid, a conductive foam, a chromia former grid or combinations thereof.

7. An electrochemical cell support structure in accordance with claim 1, wherein said grid layer comprises a plurality of interstices.

8. An electrochemical cell support structure in accordance with claim 7, wherein said plurality of interstices have a dimension in the range between about 20 to about 2500 microns.

9. An electrochemical cell support structure in accordance with claim 1, wherein said porous support layer comprises an electrode.

10. An electrochemical cell support structure in accordance with claim 9, wherein said electrode comprises a composite material.

11. An electrochemical cell support structure in accordance with claim 1, wherein said porous support layer provides a substantially smooth surface to support deposition thereupon.

12. An electrochemical cell support structure in accordance with claim 11, wherein at least one of an electrode and an electrolyte are deposited upon said porous support layer.

13. An electrochemical cell support structure in accordance with claim 12, wherein said electrode or said electrolyte are deposited using at least one of atomistic deposition techniques such as chemical vapor deposition (CVD), plasma enhanced CVD (PE-CVD), physical vapor deposition (PVD), electron beam physical vapor deposition (EB-PVD), sputter deposition, ion beam deposition, molecular beam epitaxy (MBE), spray pyrolysis or particulate deposition techniques such as plasma spray, flame spray, or high-velocity oxygen fuel thermal spray process (HVOF).

14. An electrode cell structure comprising:
a mesh substrate; and
a porous electrode material deposited upon said mesh substrate and interpenetrating therethrough.

15. An electrode cell structure in accordance with claim 14, wherein said porous electrode material is Ni and Yttria stabilized Zirconia.

16. An electrode cell structure in accordance with claim 14, wherein said porous electrode material is deposited using Physical Vapor Deposition (PVD).

17. An electrode cell structure in accordance with claim 14, wherein said porous electrode material is deposited using chemical vapor deposition (CVD), plasma enhanced CVD (PE-CVD), physical vapor deposition (PVD), electron beam physical vapor deposition (EB-PVD), sputter deposition, ion beam deposition, molecular beam epitaxy (MBE), spray pyrolysis, plasma spray, flame spray, or high-velocity oxygen fuel thermal spray process (HVOF).

18. An electrode cell structure in accordance with claim 14, wherein said mesh substrate is at least one of a stainless steel screen or a nickel screen.

19. An electrode cell structure in accordance with claim 14, wherein said mesh substrate is a metallic foil having fine holes.

20. An electrode cell structure in accordance with claim 14, wherein said mesh substrate has a thickness in the range between about 25 μm to about 75 μm.

21. An electrode cell structure in accordance with claim 14, wherein said mesh substrate comprises a plurality of grid interstices.

22. An electrode cell structure in accordance with claim 21, wherein said grid interstices size is below about 75 μm at its widest point.

23. An electrode cell structure in accordance with claim 21, wherein spacing between adjacent grid interstices is less than about 150 μm on center.

24. An electrode cell structure in accordance with claim 21, further comprises a fugitive material disposed in at least a portion of said grid interstices.

25. An electrode cell structure in accordance with claim 24, wherein said fugitive material comprises a salt.

26. An electrode cell structure in accordance with claim 25, wherein said salt comprises sodium chloride.

27. An electrochemical cell support structure comprising:
a porous conductive base; and
a support layer deposited on said porous conductive base and partially interpenetrating into said porous conductive base.

28. An electrochemical cell support structure in accordance with claim 27, wherein said porous conductive base comprises metallic foam.

29. An electrochemical cell support structure in accordance with claim 28, wherein said metallic foam is at least one of a stainless steel foam or a nickel foam.

30. An electrochemical cell support structure in accordance with claim 27, wherein said support layer material is deposited using chemical vapor deposition (CVD), plasma enhanced CVD (PE-CVD), physical vapor deposition (PVD), electron beam physical vapor deposition (EB-PVD), sputter deposition, ion beam deposition, molecular beam epitaxy (MBE), spray pyrolysis, plasma spray, flame spray, or high-velocity oxygen fuel thermal spray process (HVOF).

31. An electrochemical cell support structure in accordance with claim 27, wherein said support layer is deposited using Electron Beam Physical Vapor Deposition (EB-PVD).

32. An electrochemical cell support structure in accordance with claim 27, wherein said support layer is an electrode.

33. An electrochemical cell support structure in accordance with claim 27, wherein said support layer provides a substantially smooth surface to support further deposition thereupon.

34. An electrochemical cell support structure in accordance with claim 33, wherein at least one of an electrode and an electrolyte are deposited upon said support layer.

35. An electrochemical cell support structure in accordance with claim 34, wherein said electrode or said electrolyte are deposited using at least one of atomistic deposition techniques such as chemical vapor deposition (CVD), plasma enhanced CVD (PE-CVD), physical vapor deposition (PVD), electron beam physical vapor deposition (EB-PVD), sputter deposition, ion beam deposition, molecular beam epitaxy (MBE), spray pyrolysis or particulate deposition techniques such as plasma spray, flame spray, or high-velocity oxygen fuel thermal spray process (HVOF).

36. An electrochemical cell structure comprising:
a conductive base defining a plurality of holes passing through said conductive base;
a grid layer disposed on said conductive base;
a porous support layer at least partially interpenetrating the grid layer to at least one of the conductive base or the holes;
an first electrode layer and a second electrode layer, and an electrolyte interposed therebetween.

37. An electrochemical cell structure comprising:
a conductive base defining a plurality of holes passing through said conductive base;
a grid layer disposed on said conductive base;
a porous support layer at least partially interpenetrating the grid layer to at least one of the conductive base or the holes;
an electrolyte disposed upon said porous support layer; and
an electrode disposed upon said electrolyte.

38. An electrochemical cell structure in accordance with claim 37, wherein said porous support layer is an electrode.

39. An electrochemical cell structure in accordance with claim 38, wherein said electrolyte sealingly overlaps said porous support layer.

40. A method of fabricating an electrochemical cell support structure comprising the steps of:
providing a conductive base that comprises a plurality of through holes; attaching a grid layer to said conductive base to cover said through holes; and depositing a porous support layer to partially interpenetrate through said grid layer to at least one of said conductive base or said holes.

41. An electrochemical cell support structure in accordance with claim 1, wherein said electrochemical cell is a solid oxide fuel cell.

42. An electrochemical cell support structure in accordance with claim 1, wherein said electrochemical cell is a solid oxide electrolysis cell.
